(19) United States
(12) Patent Application Publication
(10) Pub. No.: US 2015/0259945 A1
(43) Pub. Date: Sep. 17, 2015

(54) ILLUMINATIVE SHELTER STRUCTURE

(71) Applicant: American Recreation Products, LLC., Boulder, CO (US)

(72) Inventors: Kevin Klinkel, Boulder, CO (US); Frank Kvietok, Aurora, CO (US); Erin Doubleday, Berthoud, CO (US)

(21) Appl. No.: 14/645,484

(22) Filed: Mar. 12, 2015

Related U.S. Application Data
(60) Provisional application No. 61/954,350, filed on Mar. 17, 2014.

(51) Int. Cl. E04H 15/10; F21V 1/12; F21V 17/00; F21V 21/108; F21V 19/00; F21V 7/22; F21V 33/00

(52) U.S. Cl. CPC E04H 15/10; F21V 7/22; F21V 1/12; F21V 33/008; F21V 21/108; F21V 19/00; F21V 17/00; F21W 2131/40

(57) ABSTRACT

An illumination apparatus for illuminating an interior surface of a shelter assembly is provided. The illumination apparatus includes an illumination structure coupled to the interior surface, wherein the illumination structure includes a reflective material. A light source supporting structure is coupled to the interior surface and configured to selectively position a light source in relation to the reflective material.

### CROSS-REFERENCE TO RELATED APPLICATION

This nonprovisional application claims priority to U.S. Provisional Patent Application Ser. No. 61/954,350, filed on Mar. 17, 2014, which is hereby incorporated by reference in its entirety.

### BACKGROUND

Backpacking, hiking, and camping often involve the use of assemblies, such as tents, canopies, gazeboes and the like to provide protection from the elements or otherwise provide shelter for the user(s). Typically, however, such assemblies do not include structures that facilitate lighting and illumination within the assemblies. Thus, to provide or enhance the quality of lighting inside the assembly users often use portable light sources such as flashlights, headlamps, and lanterns. However, most portable light sources provide a bright but fairly narrow cone of light, which typically only illuminates a small area of the assembly thereby leaving other areas of the assembly relatively dark.

As a result, there is a need for an assembly that redirects and/or diffuses light from a portable light source to more evenly distribute illumination throughout the assembly interior so that a significantly greater portion of the assembly is illuminated by the portable light source.

### SUMMARY

In one aspect, an illumination apparatus for illuminating an interior surface of a shelter assembly is provided. The illumination apparatus includes an illumination structure coupled to the interior surface, wherein the illumination structure includes a reflective material. A light source supporting structure is coupled to the interior surface and configured to selectively position a light source in relation to the reflective material.

In a further aspect, a shelter assembly is provided. The shelter assembly includes a shelter structure having an exterior surface and an interior surface. An illumination structure is coupled to the interior surface, wherein the illumination structure includes a first portion, a second portion, and a body located there between. The first portion is permanently coupled to the interior surface, the second portion is removably coupled to the interior surface, and the body includes at least one of a reflective material and a translucent material.

In another aspect, a shelter assembly is provided. The shelter assembly includes a shelter structure having an exterior surface and an interior surface. An illumination structure is attached to the shelter structure, wherein the illumination structure includes a first layer and a second layer. The first layer is coupled to the second layer and includes a translucent material and the second layer is coupled to the interior surface and includes a reflective material.

In yet another aspect, a method of manufacturing a shelter assembly is provided. The method includes coupling an illumination structure to the interior surface, wherein the illumination structure has a reflective material. The method includes coupling a light source supporting structure to the interior surface, wherein the light source supporting structure is configured to selectively position a light source in relation to the reflective material. A light shroud is coupled to the light support structure to facilitate illuminating the shelter assembly with the light source.

### BRIEF DESCRIPTION OF THE DRAWINGS

Features, aspects, and advantages of the present disclosure will become better understood when the following Detailed Description is read with reference to the accompanying drawings in which like characters represent like parts throughout, wherein:

FIG. 1 is a front view of an exemplary illumination apparatus and a shelter assembly of the present disclosure;

FIG. 2 is a front view of another exemplary illumination apparatus having a concave illumination structure and a light source supporting structure for use with the shelter assembly of FIG. 1;

FIG. 3 is a front view of another exemplary illumination apparatus having a convex illumination structure and a light source supporting structure for use with the shelter assembly of FIG. 1;

FIG. 4 is a schematic of another exemplary illumination apparatus having an adjustable illumination structure and light source support structure;

FIG. 5 is a schematic of another exemplary illumination apparatus in an open position;

FIG. 6 is a schematic of the illumination apparatus of FIG. 5 in a closed position;

FIG. 7 is a schematic of another exemplary illumination apparatus in an open position;

FIG. 8 is a schematic of the illumination apparatus of FIG. 7 in a closed position;

FIG. 9 is a schematic of another exemplary illumination apparatus and shelter assembly of the present disclosure;

FIG. 10 is a cross-sectional view of an illumination structure of the illumination apparatus of FIG. 9;

FIG. 11 is a perspective view of the illumination structure of FIG. 10;

FIG. 12 is a front view of the illumination structure of FIG. 11;

FIG. 13 is a schematic of the illumination structure of FIG. 9 and a light source and fastener;

FIG. 14 is a plan view of the illumination structure, the light source, and the fastener of FIG. 13; and

FIG. 15 is a flowchart illustrating an exemplary method of assembling the illumination assembly shown in FIG. 1 to the shelter structure.

### DETAILED DESCRIPTION OF THE DRAWINGS

Aspects of the present disclosure relate to illumination structures designed to disperse and diffuse light throughout a shelter structure, such as a canopy or tent. The placement and type of materials used in an illumination structure provide a user with various means for lighting the shelter structure using the user's own portable light source.

Generally, an illumination structure of the present disclosure is made from one or more materials that reflects, refracts, and/or diffuses light from light provided by a portable light source. The illumination structure may be made from opaque materials that prevent light from passing through the opaque materials. The illumination structure may be made from reflective materials that, in a mirror-like fashion, reflect light from the surface of the reflective materials causing light from a single incoming direction to be reflected into at least one outgoing direction without passing through the reflective material. The illumination structure may also be made from translucent materials that allow for light to enter through one of the translucent materials and exit through the other side of the translucent materials. The illumination structure may be made of a variety of combinations of the opaque materials, reflective materials, refractive materials, and translucent materials. Additionally, it is contemplated that materials may be used that have properties associated with a combination of the opaque materials, reflective materials, refractive materials, and translucent materials. For instance, an opaque material essentially diffusely reflects light, thereby allowing light to pass through the opaque material while also allowing light to reflect off of the opaque material. As such, the use of the terms “opaque”, “reflective”, “translucent”, and “refractive” herein may refer to one property of a material, but is not meant to limit the properties of the material. The material of the illumination structure may include a polyester oxford material such as, for example only, a poly oxford 60″ 210D450MM PU/FR/WR white coated back side.

The illumination structure can comprise any suitable material and/or textile including, but not limited to, woven fabric, nonwoven fabric, film, or other similar materials capable of reflecting light, diffusing light, refracting, and/or otherwise altering light to enhance the lighting condition inside the shelter structure. For example, a material that is translucent (e.g., a white nylon or polyester woven fabric, 100 denier or lower) may be used to diffuse light. In another example, a material that is opaque (e.g., white TYVEK, which is available from DuPont) may be used to reflect and diffuse light. In yet another example, an illumination structure comprising both an opaque material and a translucent material may work in tandem to define a channel through which light is permitted to pass, and from which diffused light exits via the translucent portion.

In some aspects, the illumination structure may have only a reflective textile made of reflective materials or a translucent textile made of translucent materials. The illumination structure having a reflective textile may be used to reflect light from a light source into the shelter structure, such as a tent. The illumination structure having a translucent textile may be positioned to have a light source behind the translucent textile where the translucency allows the light to travel through the illumination textile into the shelter structure. In additional aspects, the illumination structure may be made from two or more layers of textiles. For instance, in some aspects, the illumination structure may include a first layer made of a translucent textile and a second layer made of a reflective textile. This illumination structure may allow for light to pass through the first layer, reflect off of the second layer, and then travel back through the first layer into the shelter assembly.

The illumination structure may be removably placed in any suitable location with respect to the shelter structure. It is contemplated that the illumination structure may be a permanent structure (i.e., non-releasably attached) of the shelter assembly so that a user may always have access to the advantages provided by the illumination structure.

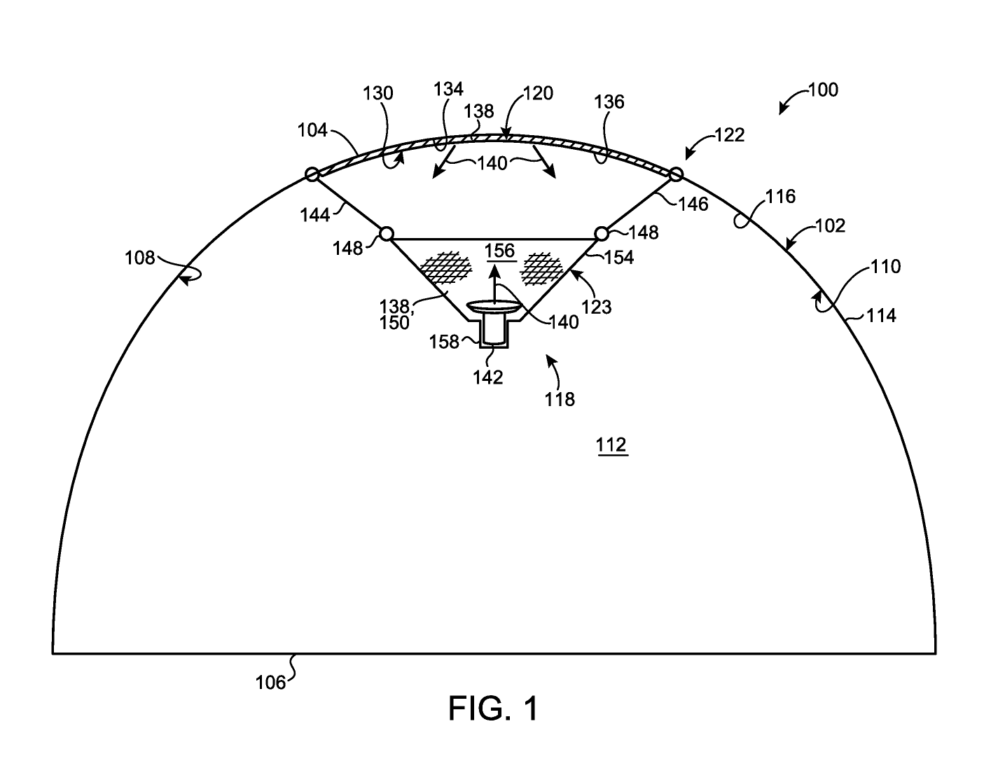

Turning now to FIG. 1, an exemplary shelter assembly, indicated generally at 100, is illustrated therein and includes a shelter structure 102. It is contemplated that the shelter structure 102 may be any suitable structure for providing a user protection from various elements including, but not limited to, tents, canopies, and gazeboes. In one particularly suitable embodiment and as seen in FIG. 1, the shelter structure 102 is a tent.

The shelter structure 102, as illustrated in FIG. 1, generally comprises one or more sheets of fabric or other material attached to and supported by a frame of poles (not shown). The shelter structure 102 can be made of any suitable material including, but not limited to, cotton, polyester, nylon, woven and/or nonwoven fabrics, films, and/or the like. The shelter structure 102 includes a top 104, a bottom 106, a first wall 108 located between the top 104 and the bottom 106, and an opposite second wall 110 also located between the top 104 and the bottom 106 configured to cooperatively define an interior space 112 of the shelter structure 102. The interior space 112 is sized and shaped for housing users (not shown) in order to protect the users from the various elements or otherwise provide the users with shelter. Although two walls 108, 110 of the shelter structure 102 are shown in FIG. 1, it is contemplated that the shelter structure 102 may have one (e.g., domed), two, three, four, or more walls. Moreover, walls 108, 110 form an exterior surface 114 and an interior surface 116.

The shelter assembly 100 further includes an illumination apparatus 118 that is coupled to the shelter structure 102. The illumination apparatus 118 includes an illumination structure 120, a light source supporting structure 122, and a light shroud 123. In the exemplary embodiment, the illumination structure 120 is coupled to the interior surface 116 of the shelter structure 102. In an embodiment, the illumination structure 120 is removably coupled to the interior surface 116. Alternatively, the illumination structure 120 can be coupled to the exterior surface 114.

FIG. 1 illustrates the illumination structure 120 being located proximate the top 104 of the shelter structure 102. However, it is contemplated that the illumination structure 120 may be located proximate other areas of the shelter structure 102, such as the bottom 106, the first wall 108, and the second wall 110 in addition to or instead of the top 104. Moreover, the illumination structure 120 may be attached to the shelter structure 102 using any suitable method such as sewing, weaving, bonding and the like. The illumination structure 120 can be permanently attached or integrated into to the shelter structure 102 or can be removably attached to the illumination structure 120. The illumination structure 120 can conform to the contours of the shelter structure 102 and can include any suitable shape including a concave shape 130. As shown in FIG. 1, the embodiment of the illumination structure 120 having the concave shape 130 corresponds to the contours of the top 104 of the shelter structure 102.

The illumination structure 120 includes a length or strip of material having a first side 134 coupled to the interior surface 116 and a second side 136 facing the interior space 112. At least one of the first side 134 and the second side 136 is made of a reflective material 138 allowing a light beam 140 that is emitted from a light source 142 to reflect off of the illumination structure 120 and throughout the interior space 112 of the shelter structure 102. The light source 142 can comprise any suitable portable light source such as, but not limited to, flashlights, headlamps and lanterns. Additionally, the light source 142 can be any suitable type such as, but not limited to, incandescent bulbs and light emitting diodes (LEDs). The light source 142 can also emit any suitable color of light beam 140.

In the exemplary embodiment, the light source supporting structure 122 is coupled to the interior surface 116 and is configured to selectively position the light shroud 123 and the light source 142 in spaced relationship relative to the reflective material 138. More particularly, the light source supporting structure 122 includes a first support 144 and a second support 146 which are coupled to the interior surface 116. In the exemplary embodiment, the first support 144 and the second support 146 include configurations such as, but not limited to, straps, lines, VELCRO, buckles, snaps, clips, buttons, and poles. Alternatively, the first support 144 and the second support 146 can include any configuration to position the light shroud 123 away from interior surface 116 and within the interior space 112. Moreover, the first support 144 and the second support 146 can be adjustable in length to selectively position the light shroud 123 within the interior space 112. Although, the light source supporting structure 122 is shown with two supports 144, 146, it is contemplated that fewer or more supports may be used.

The light source supporting structure 122 is configured to receive, hold, orientate, and/or suspend the light shroud 123 within the interior space 112. The light shroud 123 includes a shroud support 148 such as, but not limited to, straps, lines, VELCRO, buckles, snaps, clips, buttons, and poles which removably couple the light shroud 123 to the light source supporting structure 120, and in particular to the first support 144 and the second support 146. In an embodiment, the shroud supports 148 are embedded within the light shroud 123 for strength, stability, rigidity, and aesthetic purposes. The light shroud 123 is made of a material such as at least one of the reflective material 138 and a translucent material 150. In the exemplary embodiment, the light shroud 123 includes a plurality of shroud walls 154 which are coupled together to form a shroud cavity 156. Moreover, the shroud walls 154 form a light holder 158 such as, but not limited to, a pocket, a sleeve, and a tube. The light holder 158 is configured to receive, hold, orientate, and/or suspend the light source 142 toward the reflective material 138 of the illumination structure 120. In the exemplary embodiment, the light holder 158 is configured to accept a plurality of different sizes and shapes of the light sources 142. The light holder 158 may adapt, form and/or mate to the shape of the light source 142. Alternatively, the light holder 158 may provide a surface such as, for example only, a flat surface or a curved surface to hold the light source 142. In an alternative embodiment, the light holder 158 includes a gear loft. The gear loft may be an existing part of the illumination structure 102 or may be added to the illumination structure 102.

The portable light source 142 can be used by the user to selectively provide the light beam 140 within the interior space 112 of the shelter structure 102. During an exemplary use, the user couples the light shroud 123 to the first support 144 and the second support 146 using the shroud supports 148. The user can then move the light source 142 through the cavity 156 and into the light holder 158. As seen in FIG. 1, the light source 142 can be supported within the shelter structure 102 by the light source supporting structure 120 and the light shroud 123. In the exemplary embodiment, the light source supporting structure 122 is configured to hold and/or position the light shroud 123 and light source 142 to effectively illuminate the shelter structure 102, and in particular, the interior space 112 utilizing the illumination structure 120. In some embodiments, the light source supporting structure 122 is configured to position the light source 142 to face the illumination structure 120 such that the light source 142 emits the light beam 140 against the illumination structure 120.

During use, the user activates the light source 142 which emits the light beam 140 toward the reflective material 138 of the illumination structure 120. The positioning and/or shape of the reflective material 138 allows the light beam 140 to reflect off the illumination structure 120 and throughout the interior space 112 of the shelter structure 102. The light beam 140 reflects off of the illumination structure 120, and throughout the interior space 112 of the shelter structure 102. The illumination structure 120 is configured to disperse the light beam 140 such that the reflected light beam 140 facilitates enhancing illumination throughout the interior space 112. The concave shape 130 of the illumination structure further facilitates reflective dispersion of the light beam 140 within the interior space 112. Moreover, any reflected light beam 140 can transmit back through the translucent material 150 of the light shroud 123 to further illuminate the interior space 112.

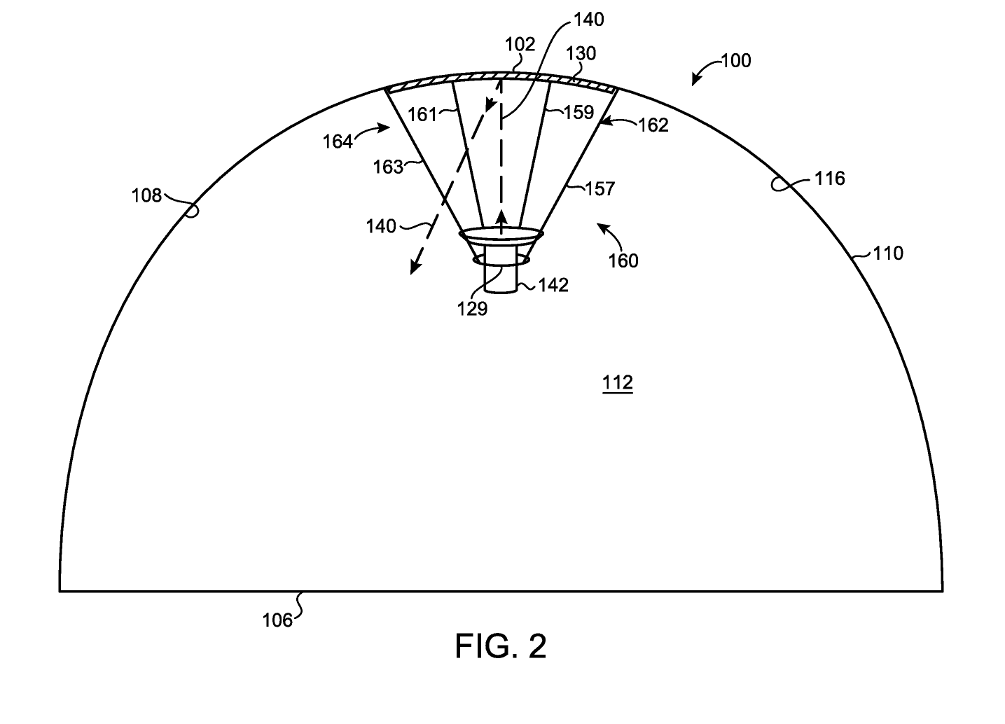

FIG. 2 illustrates another exemplary illumination apparatus 160 having a light source supporting structure 162. In FIG. 2, similar components of FIG. 1 will include the same element numbers as shown in FIG. 1. As illustrated, the light source 142 can be supported within the shelter structure 102 by the light source supporting structure 162. The light source supporting structure 162 is configured to receive, hold, orientate, and/or suspend the light source 142 to effectively illuminate the shelter structure 102, and in particular, the interior space 112 utilizing the illumination structure 120. In some embodiments, the light source supporting structure 162 is configured to position the light source 142 to face the illumination structure 120 such that the light source 142 emits the light beam 140 against the illumination structure 120 for reflection thereof. The embodiment of the light source supporting structure 162 includes a plurality of supports 164 coupled to the interior surface 116 and extending away from the reflective material 138 of the illumination structure 122.

In the exemplary embodiment, the plurality of supports 164 includes a first support 157, a second support 159, a third support 161, and a fourth support 163, that are each attached to an annular support 129 such as, for example, a retaining ring. Although the light source supporting structure 162 is shown with four supports 157, 159, 161, and 163 it is contemplated that fewer or more supports may be present. In the exemplary embodiment, the plurality of supports 164 includes configurations such as, but not limited to, straps, lines, VELCRO, buckles, snaps, clips, buttons, and poles. Alternatively, the plurality of supports 164 can include any configuration to position the annular support 129 away from interior surface 116 and within the interior space 112. Moreover, the plurality of supports 164 can be adjustable in length to selectively position the annular support 129 within the interior space 112.

The plurality of supports 164 may angularly extend from the interior surface 116 toward the annular support 129. The angular orientation facilitates coupling, capturing, orientating, and/or suspending the light source 142, having a variety of shapes and sizes, since the light source 142 can slide along the plurality of supports 164 until an effective coupling, fit, capture and/or suspension of the light source 142 by the plurality of supports 164. Alternatively, the light source 142 can directly contact the annular support 129 to facilitate coupling, capturing, orientating, and/or suspending the light source 142 within the interior space 112.

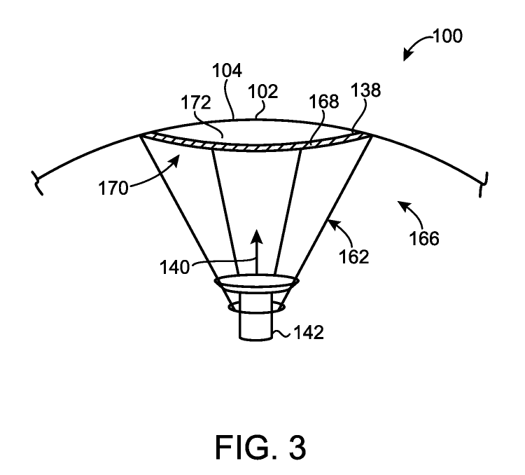

FIG. 3 illustrates another exemplary illumination apparatus 166 having an illumination structure 168 and having the light source supporting structure 162 illustrated in FIG. 2. In FIG. 3, similar components of FIGS. 1 and 2 will include the same element numbers as shown in FIGS. 1 and 2. As illustrated, the light source 142 can be supported within the shelter structure 102 by the light source supporting structure 162. The light source supporting structure 162 is configured to receive, hold, orientate, and/or suspend the light source 142 to effectively illuminate the shelter structure 102, and in particular, the interior space 112 utilizing the illumination structure 168. In some embodiments, the light source supporting structure 162 is configured to position the light source 142 to face the illumination structure 168 such that the light source 142 emits the light beam 140 against the illumination structure 168 for reflection thereof.

As shown in FIG. 3, the embodiment of the illumination structure 168 includes a convex shape 170 that extends downward and is spaced from the top 104 of the shelter structure 102. The convex shape 170 facilitates a more effective dispersal of the light beam 140 as the light beam 140 reflects from the reflective material 138 of the illumination structure 168. Moreover, as a result of the convex shape 170, a cavity 172 is formed between the top 104 of the shelter structure 102 and the illumination structure 168. In one suitable embodiment, the cavity 172 can be used by a user as a storage compartment to store various items.

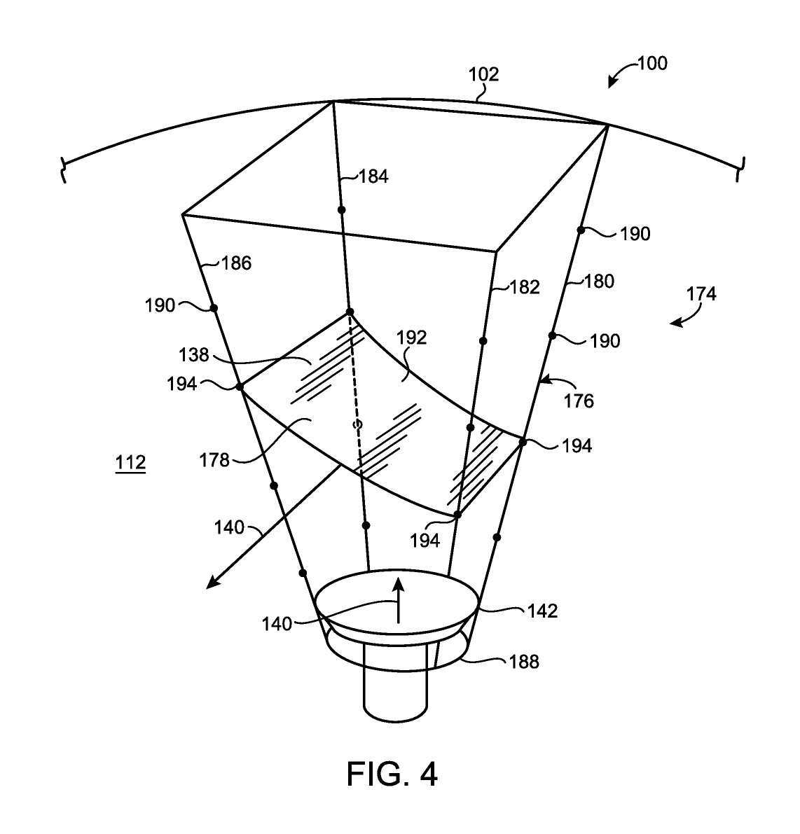

FIG. 4 illustrates another exemplary illumination apparatus 174 having a light source supporting structure 176 and an illumination structure 178. In FIG. 4, similar components of FIGS. 1-3 will include the same element numbers as shown in FIGS. 1-3. As illustrated, the light source 142 can be supported within the shelter structure 102 by the light source supporting structure 176. The light source supporting structure 176 is configured to receive, hold, orientate, and/or suspend the light source 142 to effectively illuminate the shelter structure 102, and in particular, the interior space 112 utilizing the illumination structure 178. In some embodiments, the light source supporting structure 176 is configured to position the light source 142 to face the illumination structure 178 such that the light source 142 emits the light beam 140 against the illumination structure 178 for reflection and translucence thereof. However, the light source supporting structure 176 of this embodiment allows the illumination structure 178 to be selectively and/or adjustably positioned at various locations along a length of the light source supporting structure 176. As a result, the illumination structure 178 can be selectively located at various distances from the light source 142 when the light source 142 is supported by the light source supporting structure 176. Moreover, the illumination structure 178 can be selectively located at various distances from the interior surface 116.

As illustrated, the light source supporting structure 176 includes a first support 180, a second support 182, a third support 184, and a fourth support 186 that are each attached to an annular support 188. Although the light source supporting structure 176 is shown with four supports 180, 82, 184, and 186, it is contemplated that fewer or more supports may be present. The light source supporting structure 176 also includes a plurality of attachment components 190 that allow the illumination structure 178 to be attached to various positions along the length of the light source supporting structure 176. Utilizing the attachment component 190, the illumination structure 178 can be selectively positioned by the user at locations relatively close to the top 104 of the shelter structure 102, relatively close to the bottom 106 of the shelter structure 102 or various locations there between. In an embodiment, the attachment component 190 can slide along supports 180, 182, 184, and 186.

The illumination structure 178 includes an illumination body 192 and a plurality of illumination attachment components 194 configured to mate with the attachment components 190. In the exemplary embodiment, the illumination body 192 includes a plurality of shapes such as flat and curved; and, can include a plurality of configurations such as rigid and flexible. The illumination attachment components 194 and attachment components 190 may be any suitable type of attachment means such as, for example, VELCRO, buckles, snaps, button, and the like. The illumination structure 178 is made of the reflective material 138 in order to allow light to be reflected into the interior space 112 of the shelter structure 102. The illumination structure 178 is made of the translucence material 150 in order to allow light to be transmitted into the interior space 112 of the shelter structure 102

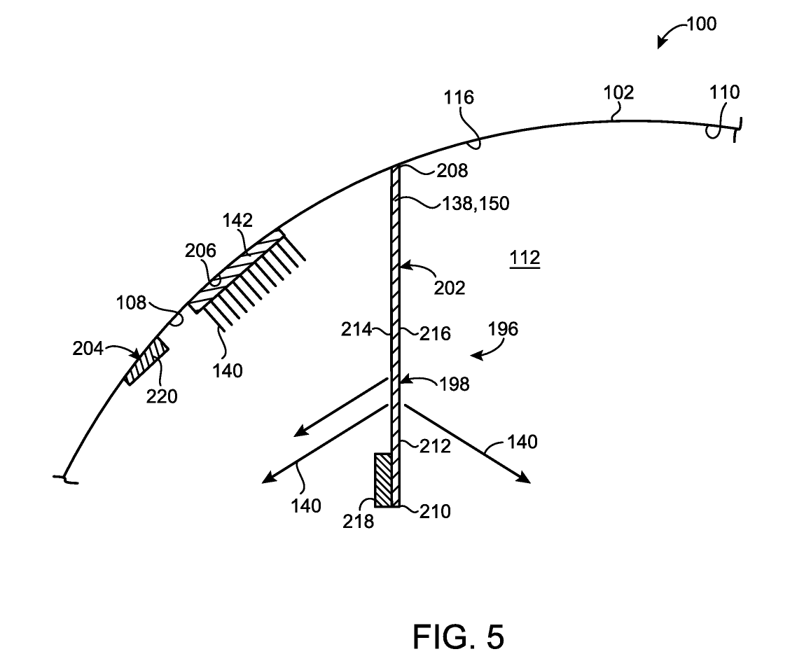

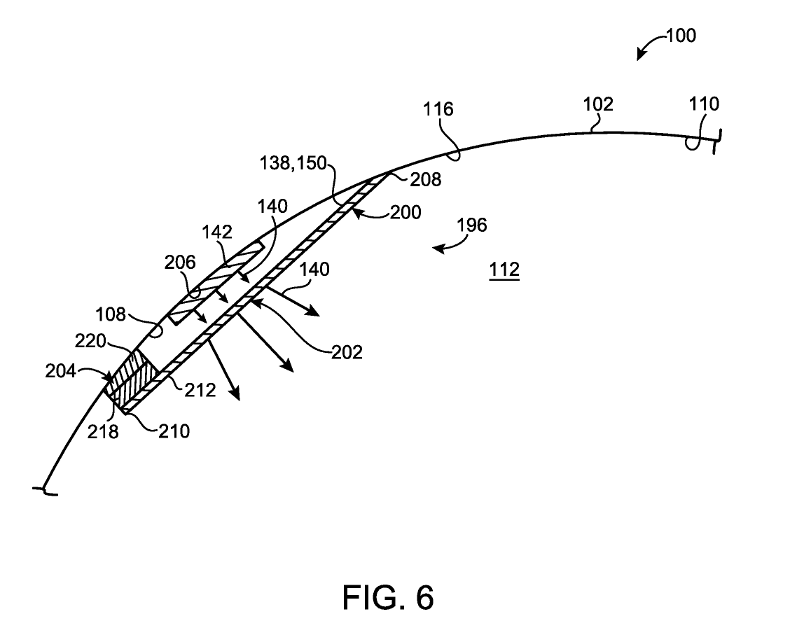

FIG. 5 illustrates another exemplary illumination apparatus 196 shown in a first position 198 such as, for example only, an open position. FIG. 6 illustrates the illumination apparatus 196 in a second position 200 such as, for example only, a closed position. In FIGS. 5 and 6, similar components of FIGS. 1-4 include the same elements numbers as shown in FIGS. 1-4. The illumination apparatus 196 includes an illumination structure 202 and a support structure 204 which is configured to removably couple the illumination structure 202 to the interior surface 116 of the shelter structure 102. Moreover, the illumination apparatus 196 includes a light source supporting structure 206 VELCRO, buckles, snaps, button, and the like. The light source supporting structure 206 may be attached to the shelter structure 102 using any suitable method such as sewing, weaving, bonding and the like. As illustrated, the light source 142 can be supported within the shelter structure 102 by the light source supporting structure 206. The light source supporting structure 206 is configured to hold or position the light source 142 to effectively illuminate the shelter structure 102, and in particular, the interior space 112 utilizing the illumination structure 202.

The illumination structure 202 includes a first portion 208, a second portion 210, and an illumination body 212 located there between. The illumination body 212 further includes a first side 214 and a second side 216. In the illustrated embodiment, the first side 214 of the illumination structure 202 faces away from the interior space 112 of the shelter structure 102 and towards a wall, such as the first wall 108 of the shelter structure 102. The opposite, second side 216 of the illumination structure 202 faces towards the interior space 112 and towards the opposite wall, such as the second wall 110 of the shelter structure 102. The illumination structure 202 may be made of the translucent material 150 that allow the light beam 140 to enter through the first side 214 of the illumination structure 202 and exit through the opposite second side 216 of the illumination structure 202. Alternatively, the illumination structure 202 may be made of the reflective material 138 that reflects the light beam 140.

The illumination structure 202 is releasably coupled to the shelter structure 102 at the second portion 210. The support structure 204 includes an illumination attachment component 218 that is configured to removably couple and mate with an attachment component 220 located on the shelter structure 102. In the illustrated embodiment, the illumination attachment component 218 is located on the first side 214 proximate the second portion 210 of the illumination structure 202. It is contemplated that the illumination attachment component 218 and attachment component 220 may be any suitable type of attachment means, such as VELCRO, buckles, snaps, button, and the like. The illumination attachment component 218 may be used along with the attachment component 220 to selectively position the illumination structure 202 within the interior space 112. For instance, as shown in FIG. 5, the illumination attachment component 218 may be decoupled from the attachment component 220 allowing the illumination structure 202 to hang freely within the interior space 112 in the first position 198. Alternatively, as shown in FIG. 6, the illumination attachment component 218 may be coupled to the attachment component 220 resulting in both the first portion 208 and the second portion 210 of the illumination structure 202 to be attached to the shelter structure 102.

In one suitable embodiment, the light source 142 may be disposed on the shelter structure 102, such as the first wall 108. It is contemplated that in some suitable embodiments the light source 142 can be releasably attached to the first wall 108 via the light source supporting structure 206. The illumination structure 202 may be selective positioned, as shown in FIG. 6, to allow light beam 140 to travel through the illumination structure 202 so that the light beam 140 is dispersed throughout the interior space 112 of the shelter structure 102. Adjustment of the illumination structure 202 utilizing the illumination attachment component 218 and attachment component 220 allows the user to selectively adjust the amount and/or direction of the light beam 140 diffused within the interior space 112 of the shelter structure 102.

Alternatively, in the first position 198, the illumination structure 202 may include the reflective material 138 which is configured to reflect the light beam 140 emitted from the light source 100. More particularly, the reflective material 138 reflects the light beam 140 toward the side wall 108 for selective illumination within the interior space 112.

During an exemplary use, the user uncouples the illumination attachment component 218 from attachment component 220 and moves the illumination structure 202 to the first position 198. The user can then couple the light source 142 to the light source supporting structure 206. The light source 142 emits the light beam 140 toward and through the translucent material 150 of the illumination structure 202 to selectively adjust the amount and/or direction of the light beam 140 diffusing within the interior space 112 of the shelter structure 102. Alternatively, when the illumination structure 202 includes the reflective material 138, the light source 142 emits the light beam 140 toward the reflective material 138. The reflective light beam 140 then effectively illuminates a portion of the interior space 112 near the first wall 108, for example.

Moreover, as illustrated in FIG. 6, the user can couple the illumination attachment component 218 to the attachment component 220 to the second position 200 to enclose the light source 100. The user can activate the light source 142 to emit the light beam 140 toward and through the translucent material 150 of the illumination structure 202 so that the light beam 140 is dispersed throughout the interior space 112.

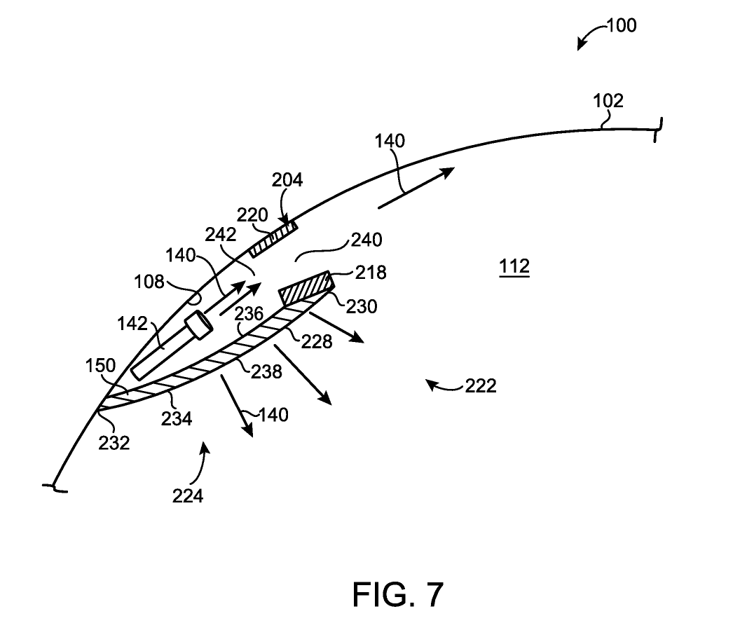

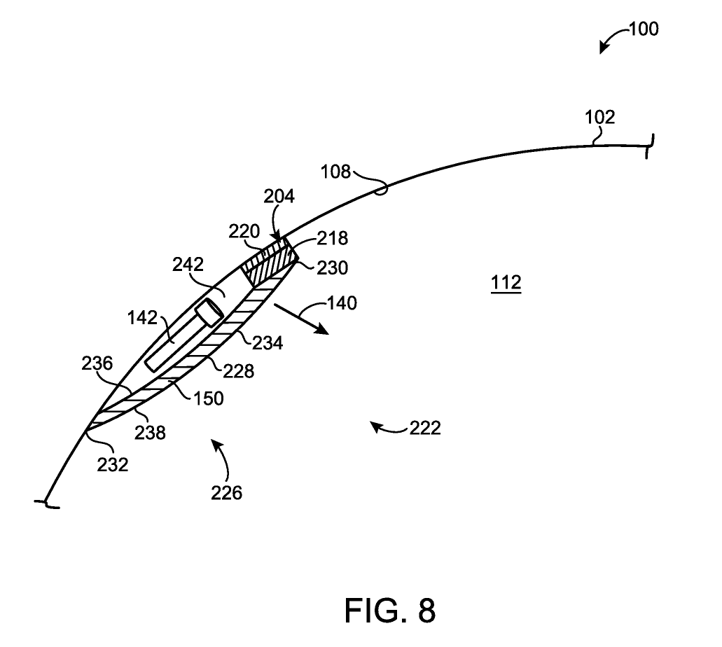

FIG. 7 illustrates another exemplary illumination apparatus 222 shown in a first position 224 such as, for example only, an open position. FIG. 8 illustrates the illumination apparatus 222 in a second position 226 such as, for example only, a closed position. In FIGS. 7 and 8, similar components of FIGS. 1-6 include the same elements numbers as shown in FIGS. 1-6. The illumination apparatus 222 includes an illumination structure 228 and the support structure 204 which is configured to removably couple the illumination structure 228 to the interior surface 116 of the shelter structure 102. As illustrated, the light source 142 can be supported within the shelter structure 102 by the illumination structure 228 which is configured to hold or position the light source 142 to effectively illuminate the shelter structure 102, and in particular, the interior space 112 utilizing the illumination structure 228.

The illumination structure 228 includes a first portion 230, a second portion 232, and an illumination body 234 located there between. The illumination body 234 further includes a first side 236 and a second side 238. In the illustrated embodiment, the first side 236 of the illumination structure 228 faces away from the interior space 112 of the shelter structure 102 and towards a wall, such as the first wall 108 of the shelter structure 102. The opposite, second side 238 of the illumination structure 228 faces towards the interior space 112 and towards the opposite wall, such as the second wall 110 of the shelter structure 102. The illumination structure 228 may be made of the translucent material 150 that allows the light beam 140 to enter through the first side 236 of the illumination structure 228 and exit through the opposite second side 238 of the illumination structure 228. Alternatively, the illumination structure 228 may be made of the reflective material 138 in order to reflect the light beam 140.

The illumination structure 228 is releasably coupled to the shelter structure 102 at the first portion 230. The support structure 204 includes the illumination attachment component 218 that is configured to removably couple and mate with the attachment component 220 located on the shelter structure 102. In the illustrated embodiment, the illumination attachment component 218 is located on the first side 236 proximate the first portion 230 of the illumination structure 228. The illumination attachment component 218 may be used along with the attachment component 220 to selectively position the illumination structure 228 within the interior space 112. For instance, as shown in FIG. 7, the illumination attachment component 218 may be decoupled from the attachment component 220 to form an opening 240 that is proximate the first portion 230. Alternatively, as shown in FIG. 8, the illumination attachment component 218 may be coupled to the attachment component 220 resulting in both the first portion 230 and the second portion 232 of the illumination structure 228 to be attached to the shelter structure 102.

The illumination structure 228 may be used with the portable light source 142 to disperse light within the shelter structure 102. In one suitable embodiment, the light source 142 may be disposed on the shelter structure 102, such as the first wall 108. It is contemplated that in some suitable embodiments the light source 142 can be releasably attached to the first wall 108 of the shelter structure 102. Alternatively, the illumination body 234 may be rigid to support the light source 142. The illumination structure 228 may be selective positioned, as shown in FIG. 8, to allow light beam 140 from the light source 142 to travel through the illumination structure 228 so that the light beam 140 is dispersed throughout the interior space 112 of the shelter structure 102. Adjustment of the illumination structure 228 utilizing the illumination attachment component 218 and attachment component 220 allows the user to selectively adjust the amount and/or direction of the light beam 140 diffused within the interior space 112 of the shelter structure 102.

During an exemplary use, the illumination structure 228 disperses light beam 140 differently based on the selective coupling and decoupling of the illumination attachment component 218 and attachment component 220. The illumination structure 228 forms a pocket 242 for receiving the portable light source 142, such as a flashlight. FIG. 7 illustrates the illumination structure 228 in the decoupled, opened position 224 while FIG. 8 illustrates the illumination structure 228 in the coupled, closed position 226. In the first opened position 224, the light beam 140 from the light source 410 is able to travel through the illumination structure 228 as well as through the opening 240 located near the first portion 230 of the illumination structure 228 to effectively illuminate the interior space 112. In the second closed position, the light beam 140 from the light source 410 is inhibited from passing through the opening 240 which limits its travel through the illumination structure 228 to effectively illuminate the interior space 112.

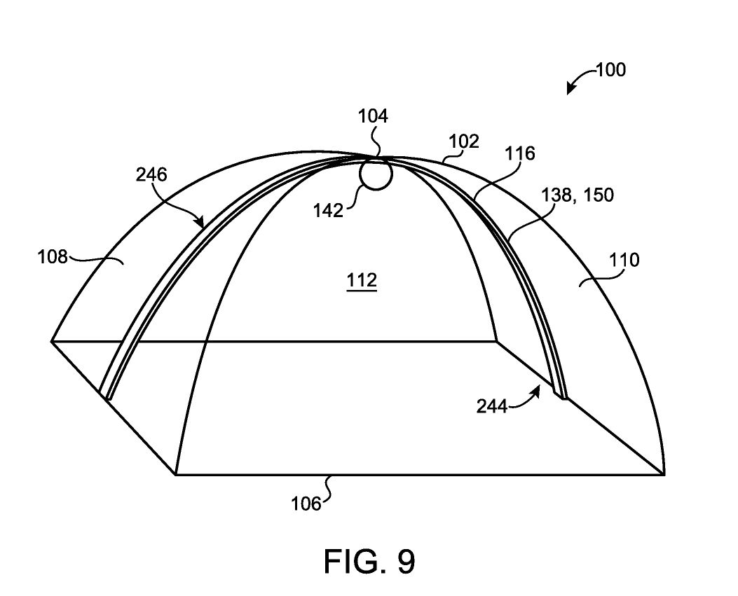

FIGS. 9-14 illustrate another illumination apparatus 244 coupled to the shelter structure 102 and having an illumination structure 246. In FIGS. 9-14, similar components of FIGS. 1-8 include the same elements numbers as shown in FIGS. 1-8. In FIG. 9, the illumination structure 246 extends from the top 104 of shelter structure 102 to the bottom 106 of the shelter structure along a wall, such as the first wall 108, and along the second wall 110 of the shelter structure from the top 104 to the bottom 106. It is contemplated that the illumination structure 246 may extend along other walls or portions of the shelter structure 102. The illumination structure 246 of this embodiment is made from a combination of the reflective material 138 and the translucent material 150.

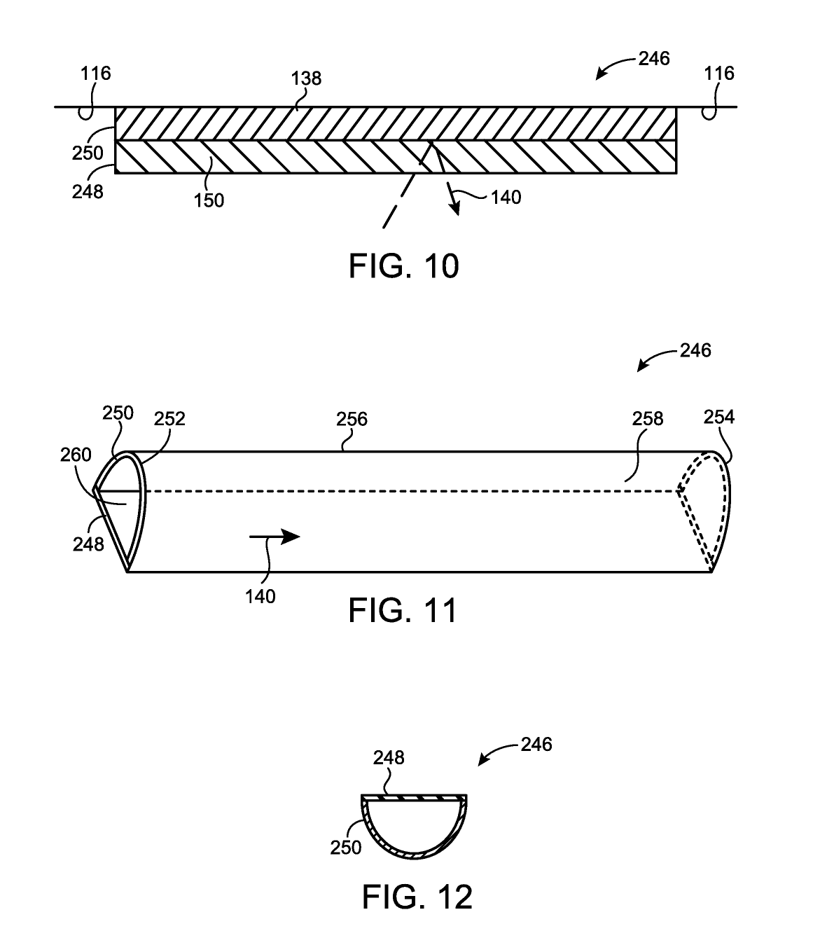

In one exemplary embodiment, the illumination structure 246 includes a first layer 248 and a second layer 250. The order of the placement of the first layer 248 and the second layer 250 facilitates the lighting and illumination of the illumination structure 246. FIG. 10 provides an exemplary cross-sectional view of the illumination structure 246. The first layer 248 is made of the translucent material 150 that allows the light beam 140 to pass through the first layer 248. The second layer 250 is a made of the reflective material 138. In the exemplary embodiment, the first layer 248 is coupled to the second layer 250 and the second layer 250 is coupled to the interior surface 116.

FIG. 11 is a perspective view of the illumination structure 246. FIG. 12 is a front view of the illumination structure 246. The first layer 248 includes a first end 252, a second end 254, and a body 256 located there between. In the exemplary embodiment, the body 256 is tubular shaped. More particularly, the body 256 includes a light guide configuration. Alternatively, the body 256 may include other non-tubular shapes. The first layer 248 may be joined to the second layer 250 in a manner that forms a cavity 258 relative to the first layer 248. Additionally, the illumination structure 246 may have an opening 260 that may be proximate the light source 142 (shown in FIGS. 9, 13, and 14) when assembled within shelter structure 102. The light source 142 may provide the light beam 140 through the opening 260 into the cavity 258 such that the light beam 140 may travel through the entirety of the illumination structure 246.

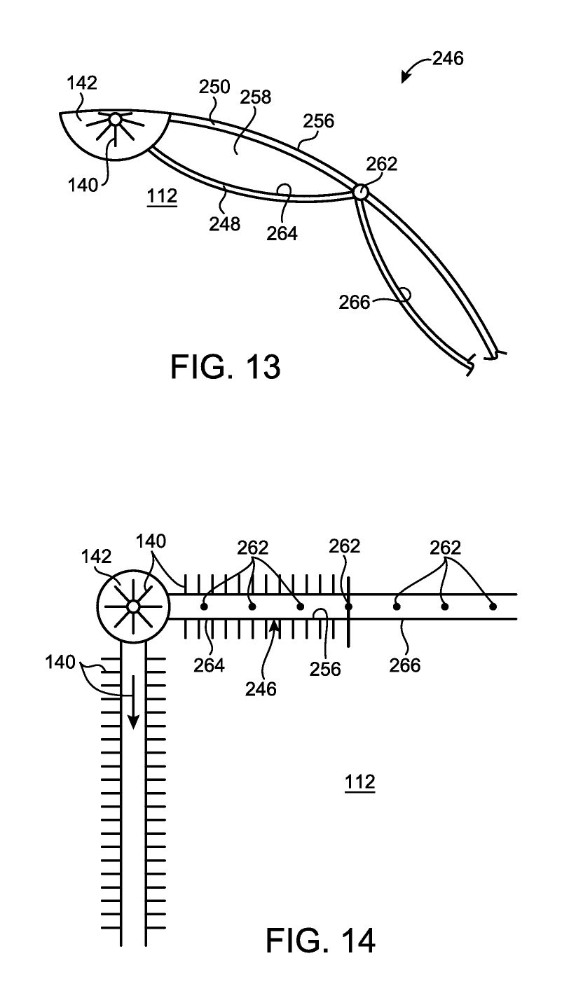

In some aspects, the illumination structure 246 may include at least one fastener 262, as shown in FIGS. 13 and 14, that allow a user to control the length and path that light beam 140 may travel along the illumination structure 246. The fastener 262 may be any suitable type of attachment means such as, for example, VELCRO, buckles, snaps, clips, button, and the like. In the exemplary embodiment, the fastener 262 includes a cinching component. The fastener 262 is configured to couple the first layer 248 to the second layer 250 to selectively segment the length of the body 256 and the cavity 258. More particularly, the fastener 262 facilitates an attachment of the first layer 248 to the second layer 250 and the blocking of the travel of light beam 140 through the illumination structure 246. For instance, as shown in FIG. 14, light from the light source 142 can travel along a first segment 264 of the body 256 but will not past the fastener 262 towards a second segment 266. Accordingly, when the plurality of fasteners 262 is left alone the cavity 202 is un-segmented within the body 256. Using the fastener 262, however, couples the second layer 250 to the first layer 248 to segment the cavity 258 into the first segment 264 and the second segment 266. The plurality of fasteners 262 can be selectively used to segment the tubular body 256 into different lengths to selectively adjust the amount of the light beam 140 reflected by the second layer 250 and/or diffused through the first layer 248 and into the interior space 112.

During an exemplary use, the light beam 140 from the light source 142 may enter the illumination structure 246, via the opening 260, to travel through the first layer 248 in a first direction, reflect off of the second layer 250, travel back through the first layer 248 in a second direction, and exit the illumination structure 246 traveling through the first layer 248 to effectively illuminate the interior space 112. The user may selectively use the plurality of fasteners 262 to adjust the length of the body 256 and the cavity 258 to selectively adjust the dispersion of the light beam 140 within the interior space 112. Moreover, in further aspects, the illumination structure 246 may be rotatable relative to the shelter structure 102 to adjust the amount and direction of the light beam 140 from the light source 142 that is dispensed with the interior space 112 of the shelter structure 102.

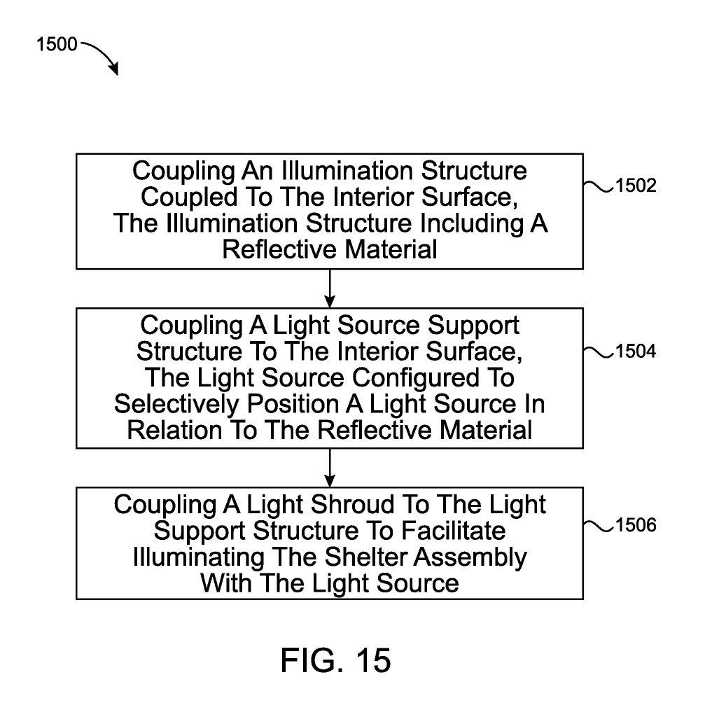

FIG. 15 is a flowchart illustrating an exemplary method 1500 of assembling an illumination apparatus, such as illumination apparatus 118 (shown in FIG. 1), to a shelter structure, for example shelter structure 102. Method includes coupling 1502 the illumination structure 130 to an interior surface, such as the interior surface 116 (shown in FIG. 1), wherein the illumination structure 130 includes a reflective material, for example the reflective material 138 (shown in FIG. 1). Moreover, in the exemplary method, a light source support structure, for example the light source supporting structure 122 (shown in FIG. 1), is coupled 1504 to the interior surface 116. The light source supporting structure 122 is configured to selectively position a light source, for example the light source 142 (shown in FIG. 1), in relation to the reflective material 138. The method 1500 further includes coupling a light shroud, such as the light shroud 123 (shown in FIG. 1), to the light support structure 122 to facilitate illuminating the shelter structure 102 with the light source 142.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An illumination apparatus for illuminating an interior surface of a shelter assembly, the illumination apparatus comprising:
an illumination structure coupled to the interior surface and comprising a reflective material; and
a light source supporting structure coupled to the interior surface and configured to selectively position a light source in relation to the reflective material.

2. The illumination apparatus of claim 1 wherein the illumination structure comprises at least one of a concave shape and a convex shape.

3. The illumination apparatus of claim 1 wherein the illumination structure comprises a convex shape which is configured to define a cavity between the reflective material and the interior surface.

4. The illumination apparatus of claim 1 wherein the light source supporting structure is removably coupled to the illumination structure.

5. The illumination apparatus of claim 1 wherein the light source supporting structure comprises a plurality of supports coupled to the interior surface, the plurality of supports are configured to extend away from the reflective material.

6. The illumination apparatus of claim 1 wherein the light source supporting structure comprises a plurality of supports coupled to the interior surface and comprises an annular support coupled to the plurality of supports.

7. The illumination apparatus of claim 1 further comprising a light shroud coupled to the light source support structure, the light shroud comprising at least one of reflective material and a translucent material.

8. The illumination apparatus of claim 1 further comprising a light shroud coupled to the light source support structure, the light shroud comprising a light holder.

9. The illumination apparatus of claim 1 further comprising a light shroud having a shroud support coupled to the light source support structure.

10. The illumination apparatus of claim 1 further comprising a light shroud coupled to the light source supporting structure wherein the illumination structure has a first length and the light shroud has a second length which is different than the first length.

11. A shelter assembly comprising:
a shelter structure comprising an exterior surface and an interior surface; and
an illumination structure coupled to the interior surface, the illumination structure comprising a first portion, a second portion, and a body located there between, wherein the first portion is permanently coupled to the interior surface, the second portion is removably coupled to the interior surface, and the body includes at least one of a reflective material and a translucent material.

12. The shelter assembly of claim 11 further comprising a support structure coupled to at least one of the interior surface and the illumination structure.

13. The shelter assembly of claim 11 further comprising a support structure coupled to the interior surface and the second portion, wherein the support structure is configured to decouple the second portion from the interior surface in a first position and couple the second portion to the interior surface in a second position.

14. The shelter assembly of claim 13 wherein, in the second position, the body is configured to define a cavity relative to the interior surface.

15. A shelter assembly comprising:
a shelter structure comprising an exterior surface and an interior surface; and
an illumination structure attached to the shelter structure, the illumination structure comprising a first layer and a second layer, the first layer is coupled to the second layer and includes a translucent material, and the second layer is coupled to the interior surface and includes a reflective material.

16. The shelter assembly of claim 15 further comprising a fastener coupled to at least one of the first layer and the second layer.

17. The shelter assembly of claim 15 wherein the second layer comprises a first end, a second end, and a tubular body located there between.

18. The shelter assembly of claim 17 wherein the tubular body is configured to define a cavity relative to the first layer.

19. The shelter assembly of claim 17 further comprising a fastener coupled to at least one of the first layer and the second layer, wherein the fastener is configured to removably couple together the first layer and the second layer to selectively adjust a length of the tubular body.

20. A method of manufacturing a shelter assembly, the method comprising:
coupling an illumination structure coupled to the interior surface, the illumination structure comprising a reflective material;
coupling a light source supporting structure to the interior surface, the light source supporting structure is configured to selectively position a light source in relation to the reflective material; and
coupling a light shroud to the light support structure to facilitate illuminating the shelter assembly with the light source.
